(19) United States
(12) Patent Application Publication
(10) Pub. No.: US 2014/0211617 A1
(43) Pub. Date: Jul. 31, 2014

(54) Method of Minimizing Power Consumption During Operation of a Battery Operated Mobile Wireless Information Device

(71) Applicant: Huawei Technologies Co., Ltd., Shenzhen (CN)

(72) Inventors: XiaoJiao Tao, Muenchen (DE); Jacob Lerenius, Kista (SE)

(21) Appl. No.: 14/144,091

(22) Filed: Dec. 30, 2013

Related U.S. Application Data
(63) Continuation of application No. PCT/EP2013/051571, filed on Jan. 28, 2013.

(51) Int. Cl. H04W 52/02; H04W 28/02; H04W 24/08

(52) U.S. Cl. CPC H04W 52/0258; H04W 24/08; H04W 28/0221
USPC 370/230

(57) ABSTRACT

A method of minimizing power consumption during operation of a battery operated mobile wireless information device having a plurality of device applications running thereon, the plurality of device applications regularly needing to communicate via the internet using wireless communication channels, the method automatically modifying a wireless transfer related behavior of the mobile wireless communication device, such that the communication channel is primarily loaded with the wireless transfer related task being more time critical during periods of low RSSI values whereas the communication channel in periods of high RSSI values may be loaded with the wireless transfer related task being less time critical. Also the disclosure relates to a battery operated mobile wireless information device capable of carrying out the method according to the disclosure.

This application is a continuation of International Application No. PCT/EP2013/051571, filed on Jan. 28, 2013, which is hereby incorporated by reference in its entirety.

### TECHNICAL FIELD

This disclosure relates to a method of enabling a wireless information device to automatically modify its wireless transfer related behavior. Also the disclosure relates to a battery operated mobile wireless information device capable of carrying out the method according to the disclosure. The term ‘wireless information device’ used in this patent specification should be expansively construed to cover any kind of device with one or two way wireless communication capabilities and includes without limitation radio telephones, smart phones, communicators, personal computers, computers and wireless enabled application specific devices such as cameras, video recorders, asset tracking systems etc. It includes devices able to communicate in any manner over any kind of network, such as WLAN, Wi-Fi, GSM or UMTS, CDMA and WCDMA mobile radio, Bluetooth, IrDA, LTE, etc.

### BACKGROUND

Enabling devices to automatically alter their behavior depending on the environment or ‘context’ of the device is a compelling foundation of ‘context aware’ computing. The basic approach of context-aware resource management is to optimize the operation of a device and its use of resources based on context. One very prominent example is to maximize battery power by using context information, and another one is to switch between available networks based on the current context. They are often realized in lower layers in the operating system.

‘Context’ can cover device specific variables such as location, as well as end-user variables such as presence. One common strand in context aware computing is the need for the device to itself become automatically aware of its context: for example, a location aware device is typically equipped with location finding equipment, such as GPS, or the ability to acquire location information from a nearby source. Equipping a device with location awareness enables new capabilities: for example, the device could automatically turn itself off when in a location in which device operation is hazardous such as in a hospital or aircraft.

The unique habits and behavior of any specific user can provide further potentials for power saving.

Improving the overall energy efficiency of this type of wireless information device is an ongoing goal. One way of improving the overall energy efficiency is equipage of the device with novel and power saving components, the use of such components, however, increases costs of producing the devices.

The recent rise in sales of both smart-phones and other data transferring mobile units has resulted in a substantial increase in the amount of data communications passing through mobile telecommunications networks. This volumetric increase can also be attributed to enhancements made to the capabilities of the networks.

This ability to use the cellular networks for mobile data services, such as Internet browsing is resulting in subscribers treating their mobile networks in much the same way as they treat their fixed networks. That is, users are tending to expect the same service from the Internet, irrespective of their access method. However, mobile networks have a more restricted capacity and are more costly to operate, as compared to fixed networks.

Access and data volumes are likely to rise faster than the revenue used to build and maintain the networks thus abilities of improved efficiency when using mobile networks to ensure that the user experience is maintained or improved even when the networks are more heavily loaded is desirable.

### SUMMARY OF THE INVENTION

On this background, it is an object of the present application to provide a method of minimizing power consumption while maintaining high data transfer capabilities in battery operated mobile wireless information devices.

This object is achieved by providing a method of minimizing power consumption during operation of a battery operated mobile wireless information device such as a cell phone, smart phone, communicator or laptop having a plurality of device applications running thereon, the plurality of device applications regularly needing to communicate via the internet using wireless communication channels, the method automatically modifying a wireless transfer related behavior of the mobile wireless communication device, comprising the steps of:
a) activating a set of wireless transfer related tasks on the mobile wireless information device,
b) running a device application on the wireless information device logging:
   an activation period of each wireless transfer related task of the set of wireless transfer related tasks,
   an amount of data transferred related to each wireless transfer related task of the set of wireless transfer related tasks, and
   an associated device application related to each wireless transfer related task of the set of wireless transfer related tasks,
c) the device application grouping the set of wireless transfer related tasks into prioritized subgroups of tasks being less or more time critical,
d) the device application logging a received signal strength indicator (RSSI) of a wireless communication channel relating to the set of wireless transfer related tasks,
e) the device application defining a wireless transfer scheme based on step a-d such that the communication channel is primarily loaded with the wireless transfer related task being more time critical during periods of low RSSI values whereas the communication channel in periods of high RSSI values may be loaded with the wireless transfer related task being less time critical.

In an embodiment the step of defining a wireless application transfer scheme comprises a step of setting a lower limit of the RSSI, the lower limit of the RSSI restraining data in the wireless transfer scheme associated with one or more groups of wireless transfer related tasks being less time critical from being transferred when the RSSI is below the lower limit.

In an embodiment the step of defining a wireless application transfer scheme comprises a step of setting a set of limits of RSSI's, the set of limits of the RSSI's defining in which intervals of RSSI values the prioritized subgroups of tasks being less or more time critical may be allowed to transfer data wirelessly.

In an embodiment the step of logging the RSSI of the wireless communication channel relating to the set of wireless transfer related tasks furthermore comprises logging a bandwidth quality of the wireless communication channel.

In an embodiment the device application is furthermore defining the wireless transfer scheme based on a step of the device application logging the battery level of the device.

In an embodiment the device application is furthermore defining the wireless transfer scheme based on a step of the device application logging the charging state level of the device.

In an embodiment the device application is furthermore defining the wireless transfer scheme based on a step of the device application monitoring a group of parameters that influences the battery consumption of the device.

In an embodiment the step of activating a set of wireless transfer related tasks comprises one or more tasks selected from the group of sending or receiving emails, RSS feeds, news updates, weather forecasts, document synchronization, antivirus updates, device application updates, SMS, viral updates, bank transfer details, virtual wallet purchase updates or other types of data transfer related tasks.

The object above is also achieved by providing a battery operated mobile wireless information device such as a cell phone, smart phone, communicator or laptop having a plurality of device applications running thereon, the plurality of device applications regularly needing to communicate via the internet using wireless communication channels, the device capable of automatically modifying a wireless transfer related behavior of the mobile wireless communication device, the device comprising:
an antenna and an RF front end capable of detecting the RSSI value of the wireless communication channel;
a processor being configured to control operation of the device including being configured to receive or transmit information via the antenna and the RF front end, and to run a device application on the device;
the processor further being configured to activate a set of wireless transfer related tasks on the mobile wireless information device;
the processor further being configured to run a device application on the wireless information device capable of logging:
an activation period of each wireless transfer related task of the set of wireless transfer related tasks,
an amount of data transferred related to each wireless transfer related task of the set of wireless transfer related tasks, and
an associated device application related to each wireless transfer related task of the set of wireless transfer related tasks;
the processor further being configured to run a device application on the wireless information device capable of grouping the set of wireless transfer related tasks into prioritized subgroups of tasks being less or more time critical;
the processor further being configured to run a device application on the wireless information device capable of logging a received signal strength indicator (RSSI) of a wireless communication channel relating to the set of wireless transfer related tasks,
the processor further being configured to run a device application on the wireless information device capable of defining a wireless transfer scheme based on step a-d such that the communication channel is primarily loaded with the wireless transfer related task being more time critical during periods of low RSSI values whereas the communication channel in periods of high RSSI values may be loaded with the wireless transfer related task being less time critical.

In an embodiment the device application of the device is furthermore capable of defining a wireless application transfer scheme furthermore is capable of setting a lower limit of the RSSI, the lower limit of the RSSI restraining data in the wireless transfer scheme associated with one or more groups of wireless transfer related tasks being less time critical from being transferred when the RSSI is below the lower limit.

In an embodiment the device application of the device is furthermore capable of defining a wireless application transfer scheme furthermore is capable of setting a set of limits of RSSI's, the set of limits of the RSSI's defining in which intervals of RSSI values the prioritized subgroups of tasks being less or more time critical may be allowed to transfer data wirelessly.

In an embodiment the device application of the device is furthermore capable of logging the RSSI of the wireless communication channel relating to the set of wireless transfer related tasks furthermore is capable of logging a bandwidth quality of the wireless communication channel.

In an embodiment the device application of the device is furthermore capable of defining the wireless transfer scheme furthermore based on the device application logging the battery level of the device.

In an embodiment the device application of the device is furthermore capable of defining the wireless transfer scheme furthermore based on the device application logging the charging state level of the device.

In an embodiment the device application of the device is furthermore capable of defining the wireless transfer scheme based on a step of the device application monitoring a group of parameters that influences the battery consumption of the device such as one of such parameters being a brightness of a screen of the device.

In an embodiment the processor is further configured to run a device application on the wireless information device capable of activating a set of wireless transfer related tasks, the set of wireless transfer related tasks comprising one or more tasks selected from the group of sending or receiving emails, RSS feeds, news updates, weather forecasts, document synchronization, antivirus updates, device application updates, SMS, viral updates, bank transfer details, virtual wallet purchase updates or other types of data transfer related tasks.

Further objects, features, advantages and properties of the engine and method of operating an engine according to the present disclosure will become apparent from the detailed description.

### BRIEF DESCRIPTION OF THE DRAWINGS

For a more complete understanding of the present invention, and the advantages thereof, reference is now made to the following descriptions taken in conjunction with the accompanying drawings, in which:

In the following detailed portion of the present description, the disclosure will be explained in more detail with reference to the exemplary embodiments shown in the drawings, in which:

FIG. 1 is a flow diagram of an embodiment of the method according to the disclosure,

FIG. 2 is a schematic flow diagram of an embodiment of the method according to the disclosure,

FIG. 3a is graphical representation of the received signal strength in a mobile device as function of time,

FIG. 3b is graphical representation of the received signal strength in a mobile device as function of time,

FIG. 4 is graphical representation of the received signal strength in a mobile device as function of time,

FIG. 5 is a block diagram of a mobile device, and

FIG. 6 is a diagrammatic representation of a mobile device network.

### DETAILED DESCRIPTION OF ILLUSTRATIVE EMBODIMENTS

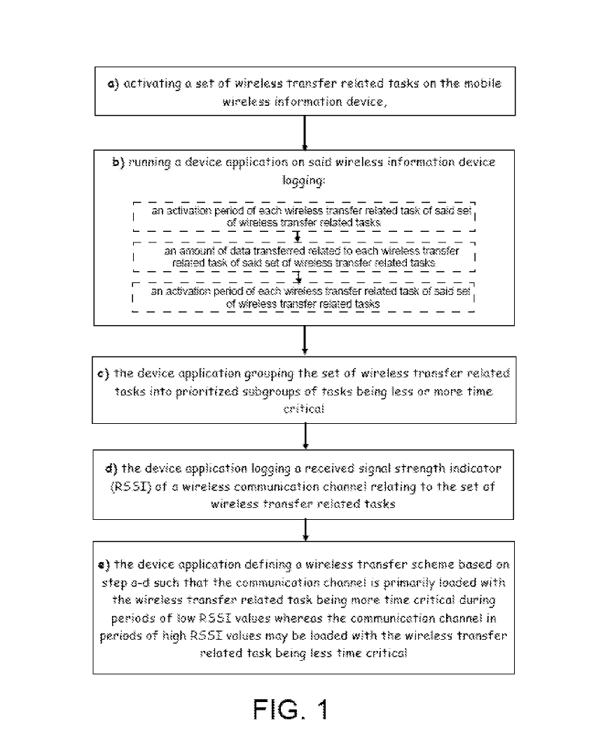

Data transfer related tasks on mobile wireless information devices become increasingly important on modern day mobile devices and the data related transfers to and from such mobile devices may be significantly improved by the present disclosure. FIG. 1 shows a flow diagram of an embodiment of the method according to the disclosure demonstrating a consecutive number of steps. The first step of the method referred to as step a) in FIG. 1 is the activation of a set of wireless transfer related tasks on the mobile wireless information device. Since the disclosure relates to wireless data transfer an essential step of the method is activation wireless transfer related tasks. The next step is referred to as step b) in FIG. 1 and is carried out when wireless transfer related tasks are active on the wireless information mobile device. The device application is logging an activation period of each wireless transfer related task of the set of wireless transfer related tasks, a period of time wherein the wireless transfer related task is active and transferring data such as the time to do an email synchronization. Also the amount of data transferred related to each wireless transfer related task of the set of wireless transfer related tasks is logged to have the behavioral history of each tasks to be able to make a just prediction of a future amount of data related to each wireless transfer related task. Finally, an associated device application related to each wireless transfer related task of the set of wireless transfer related tasks is logged in order to be able subsequently to prioritize the wireless transfer related tasks depending on their associated device application e.g., all tasks relating to e-mail synchronization may automatically be given low priority independent of both activation period and amount of data transferred only based on the associated device application. Next step c) concerns grouping the set of wireless transfer related tasks into prioritized subgroups of tasks being less or more time critical. As stated above tasks e.g., relating to e-mail synchronization may automatically be given a low priority since they mails may be synchronized during periods of high quality data transfer capability. However, different modes of operation may be superimposed to such prioritizations e.g., gaming mode, work mode, night mode, roaming mode etc. During a specific mode the prioritizing may be done differently e.g., in work mode e-mail synchronization may be given higher prioritization. Prioritizing the wireless transfer related tasks into subgroups is however an important step in all modes. The next step d) in FIG. 1 is the device application logging a received signal strength indicator (RSSI) of a wireless communication channel relating to the set of wireless transfer related tasks. The RSSI is a generic radio receiver technology metric, which is usually invisible to the user of the device containing the receiver, but is directly known to users of wireless networking. Logging the RSSI is often done in the intermediate frequency (IF) stage before the IF amplifier. In zero-IF systems, it is done in the baseband signal chain, before the baseband amplifier. RSSI output is often a DC analog level. It can also be sampled by an internal ADC and the resulting codes available directly or via a peripheral or an internal processor bus in the wireless information mobile device.

Finally, the last step e) of the method shown in FIG. 1 is the device application defining a wireless transfer scheme based on step a-d such that the communication channel is primarily loaded with the wireless transfer related task being more time critical during periods of low RSSI values whereas the communication channel in periods of high RSSI values may be loaded with the wireless transfer related task being less time critical. By defining a wireless transfer scheme based on the RSSI values and the above mentioned parameters, the energy consumption or power consumption associated with wireless data transfer may be significantly reduced. By transferring data only during periods where high RSSI values are measured and predicted a large amount of data may be transferred using less power than in conventional wireless information mobile devices, since only periods of “high quality” data transfer capability is utilized, whereas data transfer during “low quality” data transfer capability is avoided. The reason to use terms like high and low quality data transfer capability instead of using actual RSSI values is that “high quality” data transfer capabilities in periods of low RSSI values may be lower than “low quality” data transfer capabilities in periods of high RSSI values. The determination of high and low quality is therefore typically based rather on a moving average value than a fixed value. Also worth noticing is that very time critical wireless transfer related tasks will typically be executed even during periods of “low quality” data transfer capabilities e.g., critical updates, user enforced behavior to ensure user experience etc. However, all the less time critical tasks may be performed in optimum periods to save power and maximize the gain from such periods.

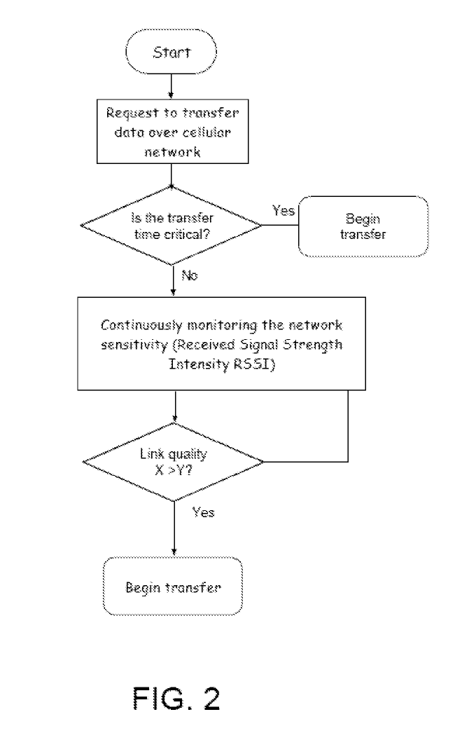

FIG. 2 shows a more schematic flow diagram of an embodiment of the method according to the disclosure. All time critical transfers are transferred after identifying that they are time-critical. All less time critical transfers are transferred when the link quality is above a certain limit X. The link quality is continuously monitored by monitoring the network sensitivity also known as the RSSI value. The limit may as explained above be a fixed value which is easy, but not very intelligent or calculated as function of time e.g., a moving average of the RSSI values. A moving average, also called rolling average, rolling mean or running average, is a type of finite impulse response filter used to analyze a set of data points by creating a series of averages of different subsets of the full data set. Given a series of numbers and a fixed subset size, the first element of the moving average is obtained by taking the average of the initial fixed subset of the number series. Then the subset is modified by “shifting forward”, that is excluding the first number of the series and including the next number following the original subset in the series. This creates a new subset of numbers, which is averaged. This process is repeated over the entire data series. The plot line connecting all the (fixed) averages is the moving average. A moving average is a set of numbers, each of which is the average of the corresponding subset of a larger set of datum points. A moving average may also use unequal weights for each datum value in the subset to emphasize particular values in the subset. A moving average is commonly used with time series data to smooth out short-term fluctuations and highlight longer-term trends or cycles, also referred to as low-pass filtering.

To carry out the method according to the disclosure the moving average may advantageously be calculated as a weighted average being any average that has multiplying factors to give different weights to data at different positions in the sample window e.g., a linearly weighted moving average.

Yₙ=AVG(f(n)*Xₙ,f(n−1)*Xₙ−1,f(n−2)*Xₙ−2, . . . f(n−o)*Xₙ₋ₒ)

Where n is the current sample number and o is the total number of previous samples included in the algorithm. Yn was used as the limit for each sample. Xn is the current sampled RSSI value. The function f(n) is the weighing factor for sample n and may be any appropriate function. In the implementation f(n) may be a look up table or a mathematical function or even a constant value.

The algorithm may also be implemented in two or more steps including conditional statements to react differently to a positive or negative derivative. A step may use the largest or smallest value between a moving average and the instantaneous value; another step may then perform another moving average of the result. An example of the calculation of a moving average may be done using the following expressions:

Zₙ=MAX (Xₙ,AVG (Xₙ,Xₙ−1,Xₙ−2, . . . ,Xₙ−ₘ) and

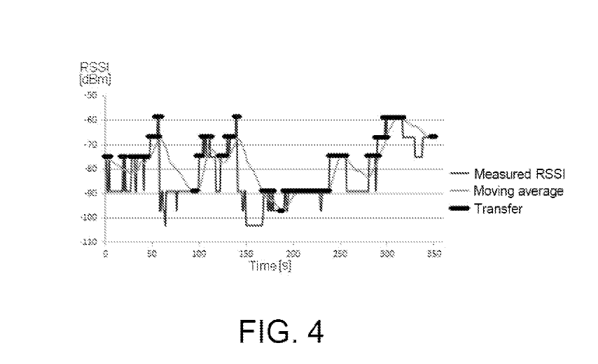

Yₙ=AVG (Zₙ,Zₙ−1,Zₙ−2, . . . Zₙ−o)

Where n is the current sample number and m and o are the total number of previous samples included in the algorithm. Yn was used as the limit for each sample. Zn is an intermediate variable in the transfer function. In FIG. 4 the following values of the previously stated expressions for the moving average: m=19, o=10 and the MAX function was used to obtain the value for each sample (n). Xn is the current sampled RSSI value.

The moving average is a way to include the past to be able to make a prediction about the future behavior of the system.

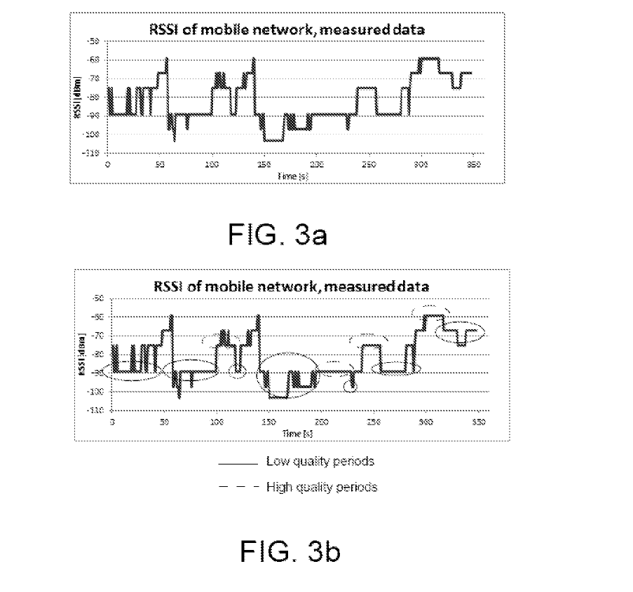

FIG. 3a is a graphical representation of a real data set of RSSI values obtained by measuring RSSI values on a mobile wireless information device. Here the mobile wireless information device was a cell phone using an Android® platform. The cell phone was measuring RSSI values while moving around in the center of Stockholm logging the RSSI values once per second and in a resolution of 2 dBm. The dataset seen in FIG. 3a shows the returned RSSI converted to dBm which spans from −113 dBm to −51 dBm during these measurements. The RSSI values returned by a receiver needs to be translated according to a definition in the wireless standard used or as defined by the receiver to obtain the value in dBm. However, it is not necessary for the implementation of this disclosure, but only to get a defined unit of the signal strength e.g., when comparing different wireless standards or systems. By glance it is evident that both periods of high and low data transfer capability has occurred during these measurements based on the information given by the receiver signal strength. Such periods are indicated by circles in FIG. 3b where circles having a full line indicate low quality periods and dashed lines indicate high quality periods.

Based on such a data set a moving average may be calculated. In FIG. 4 the same data set as presented in FIGS. 3a and 3b is shown together with a calculated two-step moving average calculation based on the RSSI values (FIG. 4 Grey line). Based on the calculated moving average a plurality of periods of high quality data transfer capability (FIG. 4 Bold line) may be determined. As seen some transfer periods are short and some are long, but all periods are high compared to the average of the period preceding the transfer period and may therefore act as a local maximum in terms of RSSI values. Therefore, if these periods are exploited to the full, power may be saved by minimizing data transfer in the remaining intervals.

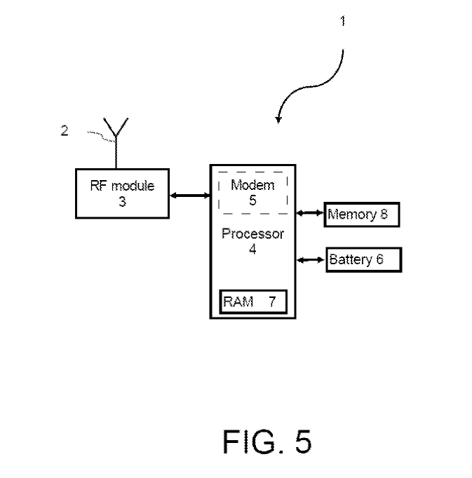

FIG. 5 illustrates in block diagram form a simplified general architecture of the mobile wireless information device 1 constructed in accordance with the present disclosure. The processor module 4 controls the operation of an RF module 3. Furthermore, the RF unit is connected to or integrated with an antenna 2. The processor 4 controls the communication with the cellular network via the RF module 3 also referred to as a RF Front end. A modem 5 is either an integrated part of the processor module 4 or a separate unit. The modem may be of GSM, UMTS, HSPA (HSDPA, HSUPA, HSPA+), CDMA2000, TD-SCDMA, LTE type or another appropriate modem type. The processor module 4 also forms the interface for some of the peripheral units of the device, including a (Flash) ROM memory 8 and a battery 6. In FIG. 5 the processor module has an integrated RAM 7.

In a radio receiver circuit, the RF front end is a generic term for all the circuitry between the antenna and the first intermediate frequency (IF) stage. It consists of all the components in the receiver that process the signal at the original incoming radio frequency (RF), before it is converted to a lower intermediate frequency (IF). In microwave and satellite receivers it is often called the low-noise block (LNB) or low-noise down converter (LND), so that the signal from the antenna can be transferred to the rest of the receiver at the more easily handled intermediate frequency.

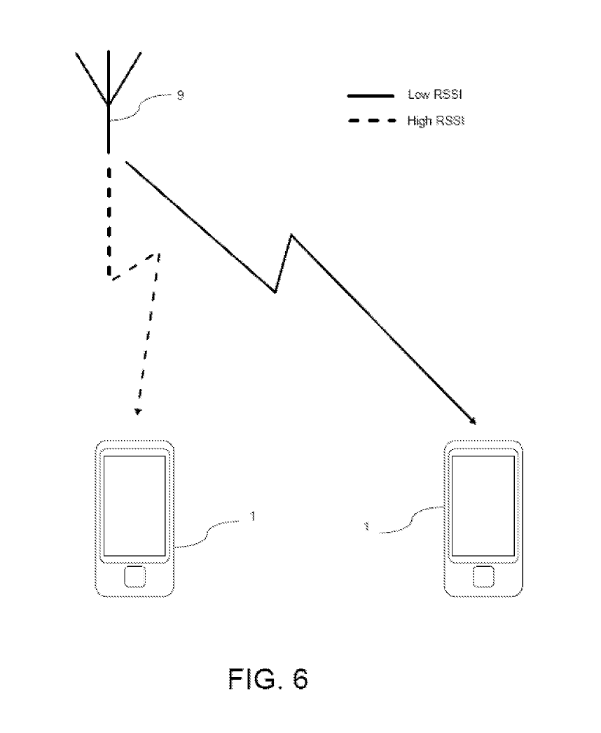

FIG. 6 shows a mobile wireless information device in a network configuration on two various positions with respect to a network antenna 9. When the mobile wireless information device 1 is close to the network antenna 9 the RSSI values are typically high indicated by the dashed line whereas when the mobile wireless information device 1 is further away from the network antenna the RSSI values are typically low indicated by the full line.

The battery of the battery operated mobile wireless information device may be any type of battery rechargeable or non-rechargeable.

The term “comprising” as used in the claims does not exclude other elements or steps. The term “a” or “an” as used in the claims does not exclude a plurality. The single processor, device or other unit may fulfill the functions of several means recited in the claims.

The reference signs used in the claims shall not be construed as limiting the scope.

Although the present disclosure has been described in detail for purpose of illustration, it is understood that such detail is solely for that purpose, and variations can be made therein by those skilled in the art without departing from the scope of the disclosure.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of minimizing power consumption during operation of a battery operated mobile wireless information device such as a cell phone, smart phone, communicator or laptop having a plurality of device applications running thereon, the plurality of device applications regularly needing to communicate via an internet using wireless communication channels, the method automatically modifying a wireless transfer related behavior of the mobile wireless information device, comprising the steps of:
a) activating a set of wireless transfer related tasks on the mobile wireless information device,
b) running a device application on the wireless information device logging:
an activation period of each wireless transfer related task of the set of wireless transfer related tasks,
an amount of data transferred related to each wireless transfer related task of the set of wireless transfer related tasks, and
an associated device application related to each wireless transfer related task of the set of wireless transfer related tasks,
c) the device application grouping the set of wireless transfer related tasks into prioritized subgroups of tasks being less or more time critical,
d) the device application logging a received signal strength indicator (RSSI) of a wireless communication channel relating to the set of wireless transfer related tasks,
e) the device application defining a wireless transfer scheme in accordance with step a-d such that the communication channel is primarily loaded with the wireless transfer related task being more time critical during periods of low RSSI values whereas the communication channel in periods of high RSSI values may be loaded with the wireless transfer related task being less time critical.

2. The method according to claim 1, wherein the step of defining the wireless application transfer scheme comprises a step of setting a lower limit of the RSSI, the lower limit of the RSSI restraining data in the wireless transfer scheme associated with one or more groups of wireless transfer related tasks being less time critical from being transferred when the RSSI is below the lower limit.

3. The method according to claim 1, wherein the step of defining the wireless application transfer scheme comprises a step of setting a set of limits of RSSI's, the set of limits of the RSSI's defining in which intervals of RSSI values the prioritized subgroups of tasks being less or more time critical may be allowed to transfer data wirelessly.

4. The method according to claim 1, wherein the step of logging the RSSI of the wireless communication channel relating to the set of wireless transfer related tasks furthermore comprises logging a bandwidth quality of the wireless communication channel.

5. The method according to claim 1, the device application furthermore defining the wireless transfer scheme in accordance with a step of the device application logging a battery level of the device.

6. The method according to claim 1, the device application furthermore defining the wireless transfer scheme in accordance with a step of the device application logging a charging state level of the device.

7. The method according to claim 1, the device application furthermore defining the wireless transfer scheme in accordance with a step of the device application monitoring a group of parameters that influences a battery consumption of the device.

8. The method according to claim 1, wherein the step of activating the set of wireless transfer related tasks comprises one or more tasks selected from the group of sending or receiving emails, RSS feeds, news updates, weather forecasts, document synchronization, antivirus updates, device application updates, SMS, viral updates, bank transfer details, virtual wallet purchase updates or other types of data transfer related tasks.

9. A battery operated mobile wireless information device such as a cell phone, smart phone, communicator or laptop having a plurality of device applications running thereon, the plurality of device applications regularly needing to communicate via an internet using wireless communication channels, the device configured to automatically modify a wireless transfer related behavior of the mobile wireless information device, the device comprising:
an antenna and an RF front end configured to detect an RSSI value of the wireless communication channels;
a processor being configured to control operation of the device including being configured to receive or transmit information via the antenna and the RF front end, and to run a device application on the device;
the processor further being configured to activate a set of wireless transfer related tasks on the mobile wireless information device;
the processor further being configured to run a device application on the wireless information device configured to log:
an activation period of each wireless transfer related task of the set of wireless transfer related tasks,
an amount of data transferred related to each wireless transfer related task of the set of wireless transfer related tasks, and
an associated device application related to each wireless transfer related task of the set of wireless transfer related tasks;
the processor further being configured to run a device application on the wireless information device configured to group the set of wireless transfer related tasks into prioritized subgroups of tasks being less or more time critical;
the processor further being configured to run a device application on the wireless information device configured to log a received signal strength indicator (RSSI) of a wireless communication channel relating to the set of wireless transfer related tasks,
the processor further being configured to run a device application on the wireless information device configured to define a wireless transfer scheme in accordance with step a-d such that the communication channel is primarily loaded with the wireless transfer related task being more time critical during periods of low RSSI values whereas the communication channel in periods of high RSSI values may be loaded with the wireless transfer related task being less time critical.

10. The battery operated mobile wireless information device according to claim 9, wherein the device application configured to define the wireless application transfer scheme furthermore is configured to set a lower limit of the RSSI, the lower limit of the RSSI restraining data in the wireless transfer scheme associated with one or more groups of wireless transfer related tasks being less time critical from being transferred when the RSSI is below the lower limit.

11. The battery operated mobile wireless information device according to claim 9, wherein the device application configured to define the wireless application transfer scheme furthermore is configured to set a set of limits of RSSI's, the set of limits of the RSSI's defining in which intervals of RSSI values the prioritized subgroups of tasks being less or more time critical may be allowed to transfer data wirelessly.

12. The battery operated mobile wireless information device according to claim 9, wherein the device application configured to log the RSSI of the wireless communication channel relating to the set of wireless transfer related tasks furthermore is configured to log a bandwidth quality of the wireless communication channel.

13. The battery operated mobile wireless information device according to claim 9, wherein the device application is configured to define the wireless transfer scheme furthermore in accordance with the device application logging a battery level of the device.

14. The battery operated mobile wireless information device according to claim 9, wherein the device application is configured to define the wireless transfer scheme furthermore in accordance with the device application logging a charging state level of the device.

15. The battery operated mobile wireless information device according to claim 9, wherein the device application configured to define the wireless transfer scheme in accordance with a step of the device application monitoring a group of parameters that influences a battery consumption of the device such as one of such parameters being a brightness of a screen of the device.

16. The battery operated mobile wireless information device according to claim 9, the processor further being configured to run a device application on the wireless information device configured to activate the set of wireless transfer related tasks, the set of wireless transfer related tasks comprising one or more tasks selected from the group consisting of sending or receiving emails, RSS feeds, news updates, weather forecasts, document synchronization, antivirus updates, device application updates, SMS, viral updates, bank transfer details, virtual wallet purchase updates or other types of data transfer related tasks.
